(19) United States
(12) Patent Application Publication
(10) Pub. No.: US 2002/0197471 A1
(43) Pub. Date: Dec. 26, 2002

(54) Compositions and methods of making temperature resistant protective tape

(75) Inventors: Scott Barnes, Renfrew (CA); Daniel Poisson, Renfrew (CA); Elwyn Huddleston, Brentwood, TN (US)

Correspondence Address: OPPENHEIMER WOLFF & DONNELLY LLP, 38TH FLOOR, 2029 CENTURY PARK EAST, LOS ANGELES, CA, 90067-3024, US

(73) Assignee: Scapa North America

(21) Appl. No.: 10/132,000

(22) Filed: Apr. 24, 2002

Related U.S. Application Data
(60) Provisional application No. 60/286,464, filed on Apr. 25, 2001.

(51) Int. Cl. B32B 7/12; B32B 15/04

(52) U.S. Cl. 428/343

(57) ABSTRACT

Compositions for making temperature resistant protective tapes utilizing halogen-free, crosslinked polymeric resins in the tape backing and an adhesive adhered thereto. Also, methods utilizing solvent free, one-step calendering processes. Such tapes are especially well suited for applications for continuous exposure to high levels of heat.

### BACKGROUND OF THE INVENTION

1. Field of the Invention

The present invention relates generally to compositions for, and methods of, making temperature resistant protective tapes. More particularly, the present invention relates to a novel tape that utilizes a unique crosslinked ethylene based, polymeric resin backing and an adhesive adhered thereto. Such tapes are especially well suited for applications in which the tapes are continuously exposed to high levels of heat. The tapes are also suited for low temperature applications due to the inherent nature of the ethylene based polymer.

2. General Background and State of the Art

Tape products are widely used in applications where cost effective protective covering is required. Applications include, but are not limited to, wire harnessing (ex. automotive and electronic) and pipeline protection. However, while protective coverings are desired, some applications in which the protection is needed would preferably use tapes with high temperature resistance (ex. one capable of withstanding a continuous operating temperature of 125° C. and greater) and low temperature resistance (ex. one capable of withstanding a continuous operating temperature as low as −40° C.). Without such temperature resistance, constituent components of the tape cease to function for their purposes by melting, cracking, etc.

Some conventional tape products utilize polyolefin backings. However, products utilizing polyethylene (PE) backings have not proven to have high temperature resistance, although low temperature properties are generally good. Other polyolefins, such as polypropylene (PP), can offer higher temperature resistance, but these polymers often suffer from poor resistance to other extreme conditions to which the tapes are exposed in industrial applications. Examples include relatively poor low temperature performance (brittleness) and a tendency to stress whiten when flexed.

In one application, PP tapes have been used in the pipeline industry. Historically, the industry has increased the service temperature of pipelines and their coatings, due to the need to increase the throughput that is accomplished by the use of higher pressure for gases, or higher temperature for oil. For a discussion see U.S. Pat. No. 6,033,776 (assigned to Scapa Tapes, herein incorporated by reference in its entirety). One example of tape utilized in that industry has been Polyken® (Division of Tyco Intl.; Norwood, Mass.; Product #1636) a polypropylene (PP) film coated with an adhesive. Here, PP is used due to the higher temperature resistance over polyethylene (PE). While this product is functional at elevated temperatures, it is not ideal and is not cost effective. The PP film must first be purchased and then coated with adhesive on rolls by a stop and go procedure, with a high amount of waste. Since PP in a very small quantity acts as a process contaminate (causes gels) to PE, manufacturers of tape products are reluctant to extrude their own film with existing PE extrusion equipment. Similarly, a pre-manufactured (purchased) PP based film could also be utilized for automotive tape applications, however, the same disadvantages exist in this application, as above.

Other conventional tape products utilize polyvinyl chloride (PVC), as opposed to polyolefins, for tape backings. PVC tapes are widely used in the automotive industry, but in applications primarily rated for 85° C. and 105° C. Thus, in general, PVC does not offer any significant thermal benefit over PE. Further, PVC is very sensitive to physical degradation. Also, by nature PVC is rigid, but is plasticized to achieve the softness and conformability needed for tape products. Plasticizer migration can occur over time causing accelerated stress cracking of the film backing and softening of the adhesive. Additionally, PVC tapes offer minimal chemical stability, and are therefore no longer used in pipeline protection applications. Lastly, PVC contains halogens that degrade upon burning, emitting hazardous compounds to the environment. Presently, the automotive industry's aggressive recycling programs are not easily achieved with parts having PVC coatings, as the incineration of the harnesses to recycle the wire results in an unacceptable release of toxic and corrosive fumes.

One conventional tape under U.S. Pat. No. 5,407,726 (assigned to The Kendall Comp., Mansfield, Mass., herein incorporated by reference in its entirety) attempts to provide a product with high temperature resistance, but does so with a halogenated (chlorinated polyethylene) backing. Again, this is not attractive to end users seeking a solution to both temperature resistance and recyclability.

U.S. Provisional Application No. 60/179,964 (assigned to Scapa Group PLC, herein incorporated by reference in its entirety) discloses a calendered, copolymer film tape that is halogen free. The backing consists of a blend of PE and EMA (Ethylene Methyl Acrylate) resulting in a soft, conformable “vinyl-like” product. It is low cost, resistant to physical and chemical degradation (ex. damage by automobile fluids, abrasion, and puncture) and has good low temperature properties. As such, it offers similar benefits as plasticized PVC tape for harnessing applications, without the use of halogens found with PVC. This advantage makes it well suited for recycling programs, described above. Also, it is low fogging by nature (whereas plasticized vinyl typically is not) and is therefore more suitable for use in automobile interior applications. However, as mentioned, neither this halogen free tape nor PVC tape provide sufficient high temperature resistance for other industrial purposes, such as those rated greater than 105° C.

Similarly, PCT Application WO071634A1 (assigned to Tyco Intl., herein incorporated by reference in its entirety) provides a halogen free tape with low fogging. Also, U.S. Pat. No. 6,200,677 (Scapa Group PLC) discloses a halogen free tape. However, neither provides sufficient high temperature resistance for other industrial purposes.

Therefore, there arises the need for filmic tapes that have high temperature resistance and are environmentally friendly (such as, halogen free) to produce and recycle. Additionally, tapes provide further benefits to serve similar and expanded purposes in the automotive and pipeline industries by maintaining structural and functional integrity, including, but not limited to: 1) reduced deformation under load (most apparent at elevated temperatures), 2) increased physical durability, including improved abrasion resistance and Environmental Stress Crack Resistance (ESCR), 3) improved chemical resistance and solvent resistance, and 4) improved simplicity and cost effectiveness of manufacture.

### INVENTION SUMMARY

The present invention provides a novel tape backing composition, and a simple and economical method of making tape product therewith, that has high temperature resistance and which is essentially halogen free.

According to the invention, there is provided a tape backing composition that is primarily comprised of crosslinked ethylene based, polymeric resin. More specifically, crosslinking is preferably achieved via the reaction of silane grafted sites on the polymer chains.

Additionally, in some embodiments, the backing composition further comprises additives, such as processing aids, heat stabilizers, antioxidants, catalysts, pigments, flame retardants and fillers.

There is also provided a method of manufacturing a tape using a one-pass calendering process by which the backing composition is simultaneously formed to the required thickness and crosslinked while being coated with an adhesive composition, for example. Furthermore, an alternative method of crosslinking such as electron beam (radiation) can be avoided entirely. Thus the economic (high capital cost) and safety related disadvantages of radiation can be avoided. A further advantage of this one-pass process is the application of a solvent free adhesive that is more economical and eco-friendly than standard methods, such as solvent coating of preformed films.

Other objects, features and advantages of the present invention will become apparent from a consideration of the following detailed description of preferred embodiments and the accompanying drawings.

### BRIEF DESCRIPTION OF THE DRAWINGS

FIG. 1 is a diagrammatic representation of a tape having a backing composition layer and a pressure sensitive adhesive layer adhered thereto.

FIG. 2 is a diagrammatic representation of methods of manufacturing temperature resistant protective tapes via a one-step calendering process where the backing and adhesive composition layers are combined in a single step.

### DETAILED DESCRIPTION OF THE PREFERRED EMBODIMENTS

In the following description of the preferred embodiments reference is made to the accompanying drawings which form the part thereof, and in which are shown by way of illustration of specific embodiments in which the invention can be practiced. It is to be understood that other embodiments can be utilized and structural and functional changes can be made without departing from the scope of the present invention.

Tape Backing Composition

According to one embodiment of the present invention, there is provided a tape backing composition that is comprised of a crosslinked ethylene based polymeric resin. Crosslinking of such materials results in a higher degree of thermal resistance of the tape backing compositions described herein, rendering these compositions well suited for high temperature applications. Examples of crosslinked resin films demonstrate the extent of enhancement to temperature and deformation resistance made according to the methods and formulations of this invention.

The polymer resins used should be selected to achieve a variety of properties depending upon the use selected for the final product. One type of polymer resin useful in this invention is silane grafted LDPE (Low Density Polyethylene) resins. These are commercially available and suited for use in conjunction with an appropriate catalyst. Examples of two such “systems” that have been found to be useful in this invention include, but not are limited to: Process Plus SX522A (density=0.92, MI=1.4) grafted LDPE and CM497 catalyst masterbatch (available from AEI Compounds Limited, Gravesend, Kent, England), Pexidan X/T A3001 (density=0.92, MI=1.6) grafted LDPE and Pexidan A/T CAT-003 catalyst masterbatch (available from Padanaplast USA Inc., Sheboygan, Wis.). These catalysts are masterbatches based on organotin compounds such as dibutyl tin dilaurate delivered in a non-reactive PE carrier and are preferred for use in this invention.

Alternatively, many grades and blends of ethylene based resins can be custom compounded, grafted with silane and potentially of use in the tape backing composition. Examples of such resins which are useful in this invention, singularly or in combination include, but are not limited to: polyethylene (PE; available from Nova Chemicals, Calgary, AB), Low Density PE (LDPE; Novapol® LE-0220-A (density=0.92, MI=2.5, Nova Chemical), Linear Low Density PE (LLDPE; Sclair® 11 L1 (density=0.92, MI=0.7, Nova Chemical), High Density PE (HDPE; Novapol® HF-Y450-A (density=0.949, MI=0.4, Nova Chemical).

Further, a range of copolymers may be used in the tape backing composition including but not limited to Ethylene Vinyl Acetate (EVA), Ethylene Methyl Acrylate (EMA), Ethylene Butyl Acetate (EBA), Ethylene Ethyl Acrylate (EEA), Ethylene Acrylic Elastomer and Ethylene Acrylic Acid (EM). Of this group of copolymers, EMA is most preferred, specifically, Chevron™ SP-2205 (available from Eastman Chemicals Co., Kingsport, Tenn.) or Optema™ TC-110 (available from Exxon Chemical Company, Houston, Tex.). Numerous grades of ethylene elastomers based on metallocene catalyst technology are also of interest including, but not limited to the Engage® 8585 (available from DuPont Dow Elastomers Company, Wilmington, Del.). It is also possible to replace the copolymer with an elastomer. Suitable elastomers include natural rubber (NR), ethylene propylene rubbers (EPR), diene terpolymers (EPDM), butyl rubber (IIR), and styrene-butadiene-styrene (SBS).

Optionally, grafted resins can blended (diluted) with ethylene polymers, copolymers and elastomers at the time of manufacture of the temperature resistant protective tape product. Polymers and copolymers miscible with grafted LPDE or which can form interpenetrating networks (IPN's) with grafted LPDE are preferred. Although the degree of crosslinking (crosslink density) is reduced by adding non-grafted resins to the composition, as is the level of temperature resistance, enhanced physical properties (higher elongation and greater conformability) can be achieved. Thus, the extent of thermal resistance and physical properties of the tape product can be optimized to suit a particular application.

Methods of Crosslinking

There are three basic methods of crosslinking PE that are currently in commercial use: 1) chemical crosslinking with peroxide, 2) radiation crosslinking and 3) silane graft crosslinking. The use of chemical and radiation crosslinking has been applied to the manufacture of tapes (for example at U.S. Pat. No. 5,407,726 assigned to Kendall). The use of silane grafted polymers in tape backing production, and particularly for the purpose of improving thermal resistance has not been addressed, and provides significant advantages over the alternative methods.

In this invention, crosslinking is preferably achieved via silane grafting of the ethylene based, polymeric resin. Generally, the silane grafting process begins with the starting material of an ethylene based, polymeric resin, such as PE. In this crosslinking method, silane is grafted to the base resin before or during use in the extrusion process. After extrusion and calendering (see Method of Manufacture, below), molecular crosslinks are created through chemical reaction with ambient moisture. Thereby, the silane grafted resin molecules crosslink. These chemical methods can be compared to the vulcanization of rubber.

However, crosslinking may also be accomplished by other chemical agents. As mentioned, organic peroxides may be used. These systems are generally not preferable, however, due to exposure of harmful and unstable substances.

In contrast, radiation crosslinking uses high-energy irradiation of the final product to cause molecular crosslinking. Thus, compared with simplistic moisture-reactive silane graft crosslinking, radiation crosslinking is significantly more expensive requiring complex technology, specialized equipment and facilities.

Further contrasting these methodologies, the molecular structure of silane crosslinked PE, for example, is very different from that of the PE crosslinked by chemical and radiation crosslinking. Chemical and radiation crosslinking (both free radical techniques) involves the formation of a network in which each crosslink point results from the coupling of two PE chains by carbon-carbon bonds. However, in silane grafting crosslinking, the multifunctionality of the silane crosslinking agent permits a chain of PE-silane to react with two or more similar chains to form networks with siloxane crosslinks. Although the nature of the molecular links is different, the end result is the same. Thus, an equally resistant tape can be prepared by a more simplistic approach than with either radiation or chemical methods.

Degree/Density of crosslinking. Varying degrees of crosslinking may be used to achieve enhanced thermal and deformation resistance. In this invention, the temperature resistant tapes preferably have a backing composition layer comprising about 50% to about 100% by weight crosslinked polyethylene polymer, and most preferably about 85% to about 90% by weight crosslinked polyethylene polymer.

In one example, using either a single ethylene based polymer or blends, the amount of silane present controls the crosslink density, which affects the physical properties of the resulting polymer. The preferred range, expressed as percent silane by weight, is from 0.2 to 3.0. The more preferred range is 0.2 to 1.8 percent. The level of silane present is relative to the total backing even though the silane may be grafted onto one polymer, which is subsequently mixed and diluted with other polymers during extrusion. In the case of the blended system, an interpenetrating network (IPN) is created which allows the system to have enhanced properties, even though the diluent polymer is free of silane grafts.

In addition to the polymeric resin, optional additives may be included in the backing layer composition, including, but not limited to processing aids, heat stabilizers, antioxidants, catalysts, pigments, flame retardants and fillers. These components are well known to those skilled in the art and are well documented. Examples of these compounds are given in the patents incorporated by reference (U.S. Pat. Nos. 5,407,726; 6,033,776 & 6,200,677, Prov. App. 60/179,964 & WO071634A1).

Antioxidants (AO's) are important to achieving good performance in applications where long term high temperature resistance is required. It is preferred that a suitable AO package be precompounded into the silane grafted base resin to ensure complete dispersion in the polymer matrix.

Although not essential, pigments are desired for both industrial and pipeline applications and can be added during the manufacture of the tape product.

Temperature Resistant Protective Tape

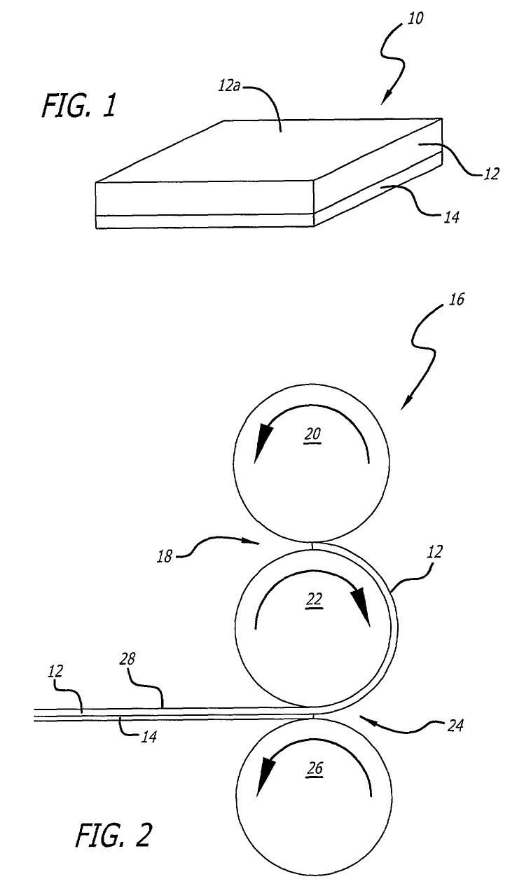

The tape backing composition described above can be used to form a tape 10 having at least one backing composition layer 12 having an upper 12a and a lower 12b surface area, and an adhesive composition layer 14 adhered thereto 12b (FIG. 1).

Preferably the tape will have the following physical properties: good initial grab (tack); high adhesion, pliable and conformable to irregular surfaces, good holding power (shear strength) and excellent temperature resistance (ex. good physical and chemical stability at temperatures of about 125° C. and greater, and most preferably from about −40° C. to about 185° C.

As is known in the art, the materials selected for the backing layer 12 and/or adhesive layer 14 compositions may be selected to achieve the above stated properties or to accomplish new properties depending upon the intended use of the tape. If needed for example, the composition of the backing layer may include various copolymers in order to increase the flexibility, to provide tapes that conform better to the surface upon which they will be applied.

Adhesive Composition Layer

The adhesive composition layer preferably comprises a semi-pressure sensitive adhesive (preferably used in conjunction with a primer system) or a pressure sensitive adhesive, which may be but is not limited to butyl rubber, natural or synthetic polyisoprene), EPR, SBR, and block copolymers (SIS, SBS, SEBS) based adhesives. Generally, butyl based adhesives are preferred for pipeline applications while numerous polymers and blends of polymers can be used for automotive applications. These adhesives are well known to those skilled in the art. Adhesives should be selected to perform at such elevated temperatures without loss of adhesion to the substrate or to the tape backing.

Adhesives can be either crosslinked or non-crosslinked varieties, although it is preferred in high temperature applications to use a crosslinked adhesive system. A number of crosslinking techniques known to those skilled in the art can be employed including, but not limited to, sulfur donor and phenolics. Depending on the polymers selected, silane chemistry could be used in the adhesives as well. Examples of crosslinkable adhesives formulated with silane chemistry are disclosed in patent WO 89/11512 (to Martin) assigned to Swift Adhesives & AEI Compounds Limited.

The adhesive composition layer may also include additives, including, but not limited to: tackifying resins, plasticizers, vulcanizing agents, stabilizers, flame retardants, bactericides, fillers and pigments.

The tape can also be formulated with non-halogen flame retardants, being admixed into the backing layer composition and/or the adhesive composition layer, and thereby give an additional benefit of flame retardancy. Non-halogenated examples include, but are not limited to organic chemicals (such as phosphorus based or boron based systems) or inorganic chemicals (such as alumina trihydrate or magnesium hydroxide). Other examples are known to those skilled in the art, or are listed in the patents incorporated by reference.

Method of Manufacture

Crosslinking Polymeric Resins. At least two methods of silane graft crosslinking are known in the art. Briefly, both involve the formation of links between polymeric macromolecules, to create a linked network of polymer chains of higher molecular weight. The resultant three-dimensional molecule is desirable over uncrosslinked material in that it is more resistant to temperature extremes, chemical attack and creep deformation which make crosslinked polymeric resins ideal for use in high temperature environments.

The Sioplas method is the basic two-step extrusion process (developed by Dow Corning) that can be used for the grafting of polymeric resins with silane, and subsequent moisture crosslinking of the grafted polymeric resin. In the first step, grafted polymeric resin and a catalyst masterbatches are obtained. The first component, grafted polymeric resin is prepared by mixing the polymeric resin mixture+silane+peroxide catalyst (such as an initiator) in a grafting extruder. The second component, the catalyst masterbatch is obtained by normal mixing and compounding, to disperse the grafting catalyst and the antioxidants throughout the same type of polymeric resin. Both masterbatches are formed into pellets and packaged separately for sale to end-users. Once received by the customer, the two masterbatches are tumble mixed just prior to use, then mixed in a conventional single screw extruder to form the finished product. Moisture is then required, during and after processing to react the silane grafts and achieve the desired physical change of the polymer.

The Monosil method is a one-step process whereby all the ingredients (silane, peroxide initiator, catalyst and antioxidant) are supplied in one masterbatch. The end-user compounds this masterbatch with a virgin polymeric resin, forms the graft sites and initiates the reaction, all in one step. For the end user, the best results in extruded parts are typically obtained using a 35:1 L/D (ratio of screw length to its diameter), extruder with precise temperature control. As with parts extruded using Sioplas resins, moisture reacts the grafted sites to achieve the necessary degree of curing. The most common use for Monosil resins is for cable coating, while Sioplas resins are most often applied in applications producing water piping.

As a reference to silane grafting methods known in the art, see U.S. Pat. Nos. 3,646,155, 4,117,195, 4,351,790, Munteanu D., Moisture-crosslinkable silane-grafted polyolefins; Symposium on Organometallic Polymers ACS; Aug. 28-31 (1993), Washington; Panzer L. M., Silane Crosslinking of polyethylene for improving product quality and simplifying the production process; Intl. Polymer Science and Technology, 25, No. 6, 1998; Gale G. M., Silane compounds in hot-water pipe and cable technology, Applied Organometallic Chemistry, 1988,2:17-31, which are hereby incorporated in their entirety by reference.

It should be recognized that either technique of silane crosslinking could be applied to produce a temperature resistant tape according to this invention. The extrusion equipment required to handle the Sioplas technology is more common to most end users than the 35:1 extruders with tight temperature control that are recommended for the Monosil approach. Since the end-user effectively grafts the silane to the polymeric resin and reacts it, gels (formed in the Monosil process) can be problematical due to poorly dispersed silane throughout the polymer. As a result, for thin film applications, the preferred method utilizes the Sioplas technology due to the need for low gel (defect) counts.

Tape formation. As mentioned above, a tape 10 having a backing composition layer 12 and an adhesive composition layer 14 may be formed in one step using a calendering process using standard equipment and standard techniques. In this process the adhesive is extruded and coated directly onto a backing substrate formed on a calender. One advantage of this method is that no solvent is needed in the coating process. As a result, it is more economical and safer than other methods of manufacture which do require the use of solvents, or result in the creation of waste material.

The tape 10 is manufactured using a one-pass calendering process whereby the backing composition layer 12 is formed directly on the calender 16 (FIG. 2).

In one embodiment of this method, backing layer extrudate 12 (such as silane grafted PE) is fed to the calender 16 through (at a temperature of about 175-195° C.) to a first nip 18, between the top roll 20 and the center roll 22 by a single screw extruder. The top roll 20 maintains a surface temperature of about 195° C., and the center roll 22 maintains a surface temperature of about 80-85° C. The heat in the extruder is sufficient to initiate the crosslinking reaction with the presence of catalyst. Once the backing layer extrudate is introduced to the calender, ambient moisture acts as a further reactant to complete the crosslinking reaction. Thus, only ambient moisture is needed to complete the crosslinking reaction of the thin, backing layer extrudate.

The backing composition layer 12, is then formed from the crosslinked polymeric resin on the center roll 22. The thickness of the backing composition layer 12 is controlled by the gap between the top roll 20 and the center roll 22. The backing composition layer 12 is then coated with an adhesive composition layer 14. In one embodiment, the adhesive composition extrudate 14 (previously admixed) is extruded at about 195-205° C. and fed to a second nip 24 between the center roll 22 and the bottom roll 26 by single screw extrusion. The bottom roll 26 maintains a temperature of about 150-165° C. The thickness of the tape adhesive is therefore controlled by the gap between the center and the bottom roll 22 and 26. The tape 10 may then be cooled by means of cooling cans. The tape may then be wound up and ready for converting.

In one alternate embodiment of the invention, a variation of the conventional Sioplas approach can be used with the presently disclosed method. The backing composition layer 12 is extruded and calendered, as above, with all components except the catalyst system. Here, the catalyst system is mixed into the adhesive composition that is extruded and calendered onto the backing composition layer during the same production step. The purpose of this approach is to delay the introduction of the catalyst system (and the crosslinking reaction) to minimize premature gel formation. Once the backing composition layer 12 is calendered and coated with the adhesive composition layer 14, the product is wound in a master roll via 28. The catalyst containing adhesive composition layer 14 contacts the backing composition layer 12 (ex. silane grafted PE film). The crosslinking reaction is catalyzed and proceeds in the presence of ambient moisture. This embodiment may be particularly useful for applications involving self-wound adhesive tapes.

The temperature resistant tape for automotive and general industrial applications will preferably have a thickness of about 4 to 9 mils, wherein the backing composition layer preferably has a thickness of about 2.5 to 6 mils and the adhesive composition layer preferably has a thickness of about 1.5 to 3 mils. Products for pipeline applications will preferably have a thickness of about 15 to 35 mils, wherein the backing composition layer preferably has a thickness of about 7 to 25 mils and the adhesive composition layer preferably has a thickness of about 5 to 30 mils.

At least one advantage of this process is that there are no extra steps required (as is the case, for example with electron beam crosslinking). A further advantage is that the method can utilize standard equipment, in contrast to the special equipment required for radiation crosslinking which costs between one and five million dollars. Also, the present method is advantageous in preventing exposure to potential health hazards from radiation where radiation crosslinking is used.

The following examples show by way of illustration and not by way of limitation the practice of this invention.

EXAMPLE 1

| Description | (%) |
|---|---|
| Backing Formulation | |
| SX522A - silane grafted LDPE | 91.0 |
| LDPE | 6.95 |
| Carbon black | 2.00 |
| Dibutyl tin dilaurate | 0.05 |
| Adhesive Formulation | |
| Vector ® 4113 (S-I-S) | 48.2 |
| Vector ® 4114 (S-I-S) | 8.0 |
| Escorez ® 1310 (C₅ Tackifier) | 25.7 |
| Adtac ® LV | 4.8 |
| Paraflex ® 168 | 12.8 |
| Irganox ® B215 | 0.5 |
| Dibutyl tin dilaurate | — |

The adhesive was prepared in advance in a sigma blade mixer and then extrusion fed to the calender. Backing materials were dry blended in the required proportions with the catalyst and carbon black contained in precompounded masterbatches. A product comprised of 4 mils of backing and 2 mils of adhesive was formed in a single pass through a 3-roll calender stack under the conditions similar to those described above. The resulting 6-mil tape was identified as X-02042.

EXAMPLE 2

| Description | (%) |
|---|---|
| Backing Formulation | |
| SX522A - silane grafted LDPE | 96.0 |
| LDPE | 2.0 |
| Carbon black | 2.0 |
| Dibutyl tin dilaurate | — |
| Adhesive Formulation | |
| Vector ® 4113 (S-I-S) | 48.15 |
| Vector ® 4114 (S-I-S) | 8.0 |
| Escorez ® 1310 (C₅ Tackifier) | 25.7 |
| Adtac ® LV | 4.8 |
| Paraflex ® 168 | 12.8 |
| Irganox ® B215 | 0.5 |
| Dibutyl tin dilaurate | 0.05 |

The adhesive was prepared in advance in a sigma blade mixer and then extrusion fed to the calender. Dibutyl tin dilaurate was added to the adhesive in a liquid form and dispersed throughout. Backing materials were dry blended in the required proportions and fed to the calender. A product comprised of 4 mils of backing and 2 mils of adhesive was formed in a single pass through a 3-roll calender stack under the similar to those described above. The resulting 6-mil tape was identified as X-02045.

EXAMPLE 3

| Description | (%) |
|---|---|
| Backing Formulation | |
| SX522A - silane grafted LDPE | 69.5 |
| LDPE | 28.46 |
| Carbon black | 2.0 |
| Dibutyl tin dilaurate | 0.04 |
| Adhesive Formulation | |
| Vector ® 4113 (S-I-S) | 48.2 |
| Vector ® 4114 (S-I-S) | 8.0 |
| Escorez ® 1310 (C₅ Tackifier) | 25.7 |
| Adtac ® LV | 4.8 |
| Paraflex ® 168 | 12.8 |
| Irganox ® B215 | 0.5 |
| Dibutyl tin dilaurate | — |

The adhesive was prepared in advance in a sigma blade mixer and then extrusion fed to the calender. Backing materials were dry blended in the required proportions with the catalyst and carbon black contained in precompounded masterbatches. Virgin LDPE (Novapol® LE-0220-A) was added and the loading of organotin catalyst reduced proportionally. A product comprised of 4 mils of backing and 2 mils of adhesive was formed in a single pass through a 3-roll calender stack under similar to those described above. The resulting 6-mil tape was identified as X-02043.

Analytical Methods

Tests for temperature resistance were conducted on the three tapes of Examples 1-3. Comparisons were made between the example products to understand the effect of crosslink density and the method of catalyst introduction. A further comparison of all products was made to that of a standard, non-crosslinked PE tape, Autolon®824. The following methods were followed to assess high temperature performance.

Hot Creep Test:

The test method for measurement of hot creep of polymeric insulation is adapted from ICEA Publication T-28-562-1995, Mar. 1995 (Insulated Cable Engineers Association, Inc. South Yarmouth, Mass.). The procedure is suited for determining the relative degree of crosslinking of XPE tapes. The test is divided in two parts.

Elongation Test:

A piece of tape (1″×6″) is subjected to a constant load stress (29 lbs./in² or 53 g for a 4-mil tape backing) while suspended in an air oven at a specified elevated temperature (ex. 125° C.) for 15 minutes. The increase in elongation of the tape is then determined while still in the oven.

Set Test:

Immediately after the elongation test has been completed on the tape, the same specimen with the load stress removed, is subjected to an additional 5 minutes in the oven at the same elevated temperature. The tape is then removed and allowed to cool at room temperature. The permanent set of the specimen, based on original length, is then determined.

Harness Bundle Test:

An in-house method to determine the inherent resistance to melting of polymer backed tape products. A bundle of 18 AWG wires covered with XPE jacketing are covered with a continuous wrap of the test tape. The harness bundle is subjected to a forced air oven at the desired temperature for 72 hours. Upon removal, the sample is cooled then examined for damage. A tape is considered resistant to a given temperature if the product shows no sign of melting and can be unwrapped from the wires with the backing intact.

Analytical Data

| | |
|---|---|
| 125° C. | 150° C. |

| | | | | |
|---|---|---|---|---|
| Tape | Elongation | Set | Elongation | Set |

| Hot Creep | | | | |
|---|---|---|---|---|
| X-02042 | 2% | −10% | 71% | −28% |
| X-02045 | 10% | −5% | 120% + | — |
| X-02043 | 8% | −8% | Fail | — |
| Autolon ® 824 | Fail | — | Fail | — |

| | 125° C. | 150° C. | 175° C. |
|---|---|---|---|
| Harness Bundle | | | |
| X-02042 | Pass | Pass | Pass |
| X-02045 | Pass | Pass | Pass |
| X-02043 | Pass | Pass | Pass |
| Autolon ® 824 | Fail | Fail | Fail |

| | Tensile Strength | Ultimate Elongation |
|---|---|---|
| | (lb./in.) | (%) |
| Mechanical Properties (per ASTM D1000) | | |
| X-02042 | 20 | 75 |
| X-02045 | 20 | 110 |
| X-02043 | 21 | 100 |
| Autolon ® 824 | 12 | 85 |

As shown above, all tapes outperformed test tape (Autolon® 824) in each of the tests conducted. By way of comparison, the test tape (Autolon® 824) melted quickly at 125°C. when submitted to the Hot Creep test. In contrast, the crosslinked resin based tapes showed excellent performance at 125°C., while fully crosslinked samples performed best at 150°C. Of note, the sample tape having the crosslinking catalyst present in the adhesive layer (X02045) showed improved properties over the test tape. Thus, even where diluted cross-linking may occur due to locating the catalyst in the adhesive, rather than admixing directly with the backing compound, thermal properties are improved over known tapes. Crosslinking dilution which may arise in this embodiment may be improved by use of stronger or a higher concentration of the catalyst in the adhesive.

Further, under simulation of the wire harnessing application, the 3 XPE based tapes are performing very well, even at 175° C. The 3 XPE tapes may soften, as indicated by the Hot Creep test results, but maintain sufficient integrity to hold the harness together and protect it adequately. As expected, the regular LDPE based tape Autolon® 824 is not able to sustain the heat at temperatures of 125° C. and above.

Thus, the tensile strength of XPE based tapes is superior to a LDPE based product. This increased strength supplied by crosslinking was not shown to compromise the ultimate elongation and hence the conformability of the tape.

As can be appreciated, alternative methods of practicing this invention can be envisioned. For example, production technologies known to those skilled in the art such as tandem extrusion or co-extrusion may be utilized to form the layers of the tape product. Further, a preformed backing layer may be utilized onto which adhesive is applied in any way known or developed. Further, a preformed backing layer and/or preformed adhesive layers may be utilized. Preferably in any of these embodiments, the backing material comprises a cross-linked ethylene based, polymeric resin, and most preferably silane cross-linked resin. Also, preferably the adhesive material comprises a catalyst for the cross-linking reaction. Further, the tape product is preferably halogen free and has high performance at elevated temperatures.

We claim:

1. A temperature resistant tape having a thickness comprising:
a backing composition layer having an upper and a lower surface area, wherein the backing composition comprises a crosslinked ethylene polymer; and
an adhesive composition layer adhered to the backing composition layer lower surface area.

2. The tape of claim 1, wherein the crosslinked ethylene polymer is at least one selected from the group comprising: polyethylene, low density polyethylene, linear low density polyethylene and high density polyethylene.

3. The tape of claim 1, wherein the backing composition further comprises at least one copolymer selected from the group comprising: ethylene vinyl acetate, ethylene methyl acrylate, ethylene butyl acetate, ethylene ethyl acrylate, ethylene acrylic elastomer and ethylene acrylic acid.

4. The tape of claim 1, wherein the backing composition further comprises at least one elastomer selected from the group comprising natural or synthetic polyisoprene, ethylene propylene rubber, diene terpolymers, butyl rubber and styrene-butadiene.

5. The tape of claim 1, wherein the crosslinked ethylene polymer is crosslinked by silane grafting.

6. The tape claim 1, wherein the backing layer composition further comprises about 0.2 to about 3.0 percent by weight of silane.

7. The tape claim 1, wherein the backing layer composition further comprises about 0.2 to about 1.8 percent by weight of silane.

8. The tape of claim 1, wherein the backing layer composition further comprises at least one additive selected from group comprising: process aids, heat stabilizers, antioxidants, catalysts, pigments, flame retardants and fillers.

9. The tape of claim 1, wherein the adhesive composition layer comprises a pressure sensitive adhesive or a semi-pressure sensitive adhesive.

10. The tape of claim 9 wherein the adhesive composition is crosslinked.

11. The tape of claim 9 wherein the adhesive composition layer comprises at least one of the items selected from the group including: butyl rubber, natural rubber, ethylene propylene rubber, polyisoprene, styrene-isoprene-styrene, styrene-butyl-styrene or styrene-ethylene-butyl-styrene.

12. The tape of claim 9 wherein the adhesive layer of claim 1 further comprises additives selected from the group comprising: tackifying resins, plasticizers, vulcanizing agents, stabilizers, flame retardants, bactericides, fillers, catalysts and pigments.

13. The temperature resistant tape of claim 1 wherein the adhesive composition layer and the backing composition layer are halogen free.

14. A temperature resistant tape having a thickness comprising:
a backing composition layer having an upper and a lower surface area, the backing composition comprising a silane crosslinked low density polyethylene polymer; and
an adhesive composition layer adhered to the backing composition layer lower surface area, the adhesive composition comprising a pressure sensitive adhesive or a semi-pressure sensitive adhesive.

15. The temperature resistant tape of claim 14 wherein the backing composition layer comprises about 50% to about 100% by weight silane crosslinked low density polyethylene polymer.

16. The temperature resistant tape of claim 14 wherein the backing composition layer comprises about 85% to about 90% by weight silane crosslinked low density polyethylene polymer.

17. The tape of claim 14 wherein the adhesive composition is crosslinked.

18. The temperature resistant tape of claim 14 wherein the backing composition layer and adhesive composition layer are substantially halogen free.

19. A temperature resistant tape having a thickness comprising:
a backing composition layer having an upper and a lower surface area, the backing composition comprising at least about 85 to about 90% by weight of crosslinked low density polyethylene polymer; and
an adhesive composition layer adhered to the backing composition layer lower surface area, the adhesive composition comprising a crosslinked pressure sensitive adhesive,
wherein the backing composition layer and adhesive composition layer are substantially halogen free.

20. A temperature resistant tape having a thickness comprising:
a backing composition layer having an upper and a lower surface area, the backing composition comprising a crosslinkable ethylene polymer; and
an adhesive composition layer adhered to the backing composition layer lower surface area, the adhesive composition comprising a pressure sensitive adhesive or a semi-pressure sensitive adhesive, the adhesive further having a catalyst for curing the crosslinkable ethylene polymer.

21. The temperature resistant tape of claim 1, 14, 19 or 20 which maintains its structural and chemical integrity at temperatures exceeding about 125° C.

22. The temperature resistant tape of claim 1, 14, 19 or 20 which maintains its structural and chemical integrity over a temperature range of about −40° C. to about 185° C.

23. An article of manufacture comprising a substrate having a surface area and a temperature resistant tape of claim 1, 14, 19 or 20 adhered to the surface of the substrate.

24. The method of manufacturing a temperature resistant protective tape comprising the steps of:
a. extruding a backing composition containing crosslinkable ethylene based, polymeric resin and a catalyst at a selected temperature to a first calender nip, between a top roll at a selected temperature and a center roll at a selected temperature;
b. forming a backing composition layer on a center roll at a selected temperature;
c. extruding an adhesive composition at a selected temperature to a second nip between the center roll at a selected temperature and a bottom roll at a selected temperature;
d. forming a tape comprising the backing composition layer and an adhesive composition layer;
e. reacting the crosslinkable ethylene based polymeric resin to form crosslinks in the backing composition.

25. The method of manufacturing a temperature resistant protective tape comprising the steps of:
a. extruding a backing composition containing crosslinkable ethylene based, polymeric resin at a selected temperature to a first calender nip, between a top roll at a selected temperature and a center roll at a selected temperature;
b. forming a backing composition layer on a center roll at a selected temperature;
c. extruding an adhesive composition including a catalyst for crosslinking at a selected temperature to a second nip between the center roll at a selected temperature and a bottom roll at a selected temperature;
d. forming a tape comprising the backing composition layer and an adhesive composition layer;
e. reacting the crosslinkable ethylene based polymeric resin to form crosslinks in the backing composition.

26. The method of claim 24 or 25, wherein ambient moisture acts as a reactant for the crosslinkable resin.

27. The method of claim 24 or 25 wherein the crosslinking ethylene based, polymeric resin is silane crosslinked low density polyethylene.

28. The method of manufacturing a temperature resistant protective tape comprising the steps of:
a. obtaining a backing layer material comprising a crosslinkable polymeric resin;
b. applying an adhesive layer material to the backing layer material, the adhesive having a catalyst for reacting with the crosslinkable polymeric resin;
c. reacting the crosslinkable polymeric resin to form crosslinks in the backing layer material.

29. The method of manufacturing a temperature resistant protective tape comprising the steps of:
a. obtaining a backing layer material comprising a crosslinkable polymeric resin;
b. applying an adhesive layer material to the backing layer material;
c. reacting the crosslinkable polymeric resin to form crosslinks in the backing layer material.

30. The method of claim 28 or 29 wherein the crosslinkable ethylene based, polymeric resin is silane crosslinkable low density polyethylene.

31. The method of claim 28 or 29 wherein ambient moisture acts as a reactant for the crosslinkable resin.

32. The method of claim 28 or 29 wherein the method of manufacture is substantially free of halogen.
